(19) United States
(12) Patent Application Publication
(10) Pub. No.: US 2014/0316560 A1
(43) Pub. Date: Oct. 23, 2014

(54) VENDING MACHINE CONTROLLER WITH INNOVATIVE DISPLAY FEATURES

(71) Applicant: COIN ACCEPTORS, INC., St. Louis, MO (US)

(72) Inventors: Ronald A. Hoormann, St. Charles, MO (US); Thomas Franklin Unsicker, Shrewsbury, MO (US); Patrick Wayne Keeven, St. Louis, MO (US)

(73) Assignee: COIN ACCEPTORS, INC., St. Louis, MO (US)

(21) Appl. No.: 14/360,206

(22) PCT Filed: Nov. 21, 2012
(86) PCT No.: PCT/US12/66343

§ 371 Date: May 22, 2014

Related U.S. Application Data
(60) Provisional application No. 61/562,598, filed on Nov. 22, 2011.

(51) Int. Cl. G07F 9/02; G06Q 30/02

(52) U.S. Cl. CPC G07F 9/023; G06Q 30/0207
USPC 700/232

(57) ABSTRACT

A vending having a vending machine controller for calculating credit acceptance, calculating credit return, signaling product dispensing, displaying information on a display, monitoring environmental conditions, and controlling lighting. Coin and bill acceptors are also included that receive and validate coins and bills and, optionally, pay coins and bills back as change. A product dispenser vends product in response to a signal from the vending machine controller. A cashless payment device reads a customer's cashless payment device and transmits the cashless payment information to the vending machine controller. Finally, the vending machine controller includes a network interface controller for communicating information about the customer's cashless payment device across a network and for receiving information about whether the cashless payment device is valid for making a purchase from the vending machine. A touch screen display communicates messages from the vending machine controller to a customer and interprets customer contact with the display.

This application is related to application U.S. Provisional Patent Application Ser. No. 61/515,219, filed Aug. 4, 2011 and U.S. patent application Ser. No. 13/042,451, filed Mar. 7, 2011. These applications are incorporated herein by reference.

### FIELD OF THE INVENTION

This invention relates generally to vending machines and more particularly, to those equipped with a Coin Changer for accepting customer credit in the form of coins, a Bill Validator for accepting customer credit in the form of currency, a Cashless Device for facilitating the acceptance of customer credit in the form of credit cards, and a Vending Machine Controller. The VMC is the “brains” of the system responsible for managing credit acceptance, credit return, product dispensing, displayed information, environmental conditions for the inside products, lighting, etc.

### BACKGROUND OF THE INVENTION

Many existing vending machines include vending machine controllers (VMCs) configured for operation with Coin Changers having three or more coin tubes, each coin tube storing a respective coin denomination and Bill Validator devices capable to validate multiple currencies. Operation of such vending machines is typically as follows. The changer validates and determines the denomination of incoming coins and communicates the value of each accepted coin to the VMC. The changer also communicates the status of the three or more coin tubes (full, empty, or number of coins) to the VMC. The Bill Validator validates and determines the denomination of the incoming bill and communicates the value to the VMC. The VMC accumulates credit by adding and storing each coin value received from the changer and each bill value received from the Bill Validator, controls the vend operation, and thereafter determines the change to be paid out, if any. Although the three or more coin tubes are associated with the changer, it is the VMC which controls payout of coins. One way to accomplish this is having an interface of the VMC and the Coin Changer that includes three or more lines, one associated with each coin tube. When the VMC affects a signal on a given coin tube line, a coin is paid out from the respective coin tube by operation of a solenoid, motor, or any other known payout means. For example, each time the VMC effects a high signal on a given coin tube line, the payout means is activated and a single coin is paid out from the respective coin tube. Multiple coins are similarly paid out from a given coin tube by multiple high signals on the coin tube's associated interface line. Another way to accomplish this is having an interface of the VMC and the Coin Changer that is capable to transfer commands from the VMC to the Coin Changer and responses from the Coin Changer to the VMC. All the commands and responses form a PROTOCOL that is understood by both Coin Changer and VMC. Thus, in a traditional system that has a VMC, a Coin Changer with three or more tubes and a Bill Validator for validating currency, the VMC directly controls change payout from the Coin Changer's three or more coin tubes using one of the two methods described above.

The demand for vending machines capable of paying out change from coin tubes and, particularly, capable of accepting and paying out change from a Bill Validator equipped with a Dispenser box that accepts bills and is capable to recycle these bills is ever increasing. One way to accomplish this is to replace the existing VMC with a new VMC that has additional interface lines directed to the Bill Validator-Dispenser box and controlling the dispensing of bills similar to the lines directed toward the Coin Changers having multiple coin tubes, each coin tube storing one coin denomination. Another way to accomplish this is to replace the existing VMC with another VMC that has an additional set of command-responses for communications between the VMC and the Bill Validator-Dispenser. Such modifications that will allow the replacement of a classic Bill Validator with a new Bill Validator-Dispenser are costly and time consuming, particularly when performed during re-installation of an existing Vending Machine located in the field.

The patent application “Method and Apparatus for controlling the operation of a Coin Changer and a Bill Validator-Dispenser in an existing Vending Machine” filed Mar. 7, 2011 with the Ser. No. 13/042,451 shows the advantages of an Adapter Box located between the VMC and the coin and currency accepting devices.

Accordingly, it is desirable and advantageous to provide an Interface Adapter Device for allowing a Bill Validator-Dispenser to be easily installable in and operable within existing vending machines. It also is desirable and advantageous to provide a method of controlling change payout from both Coin Changer with multiple tubes and Bill Validator-Dispenser installed in a vending machine having no need to change the VMC hardware or software.

The demand for vending machines capable of accepting payment via customer credit cards is becoming more and more acute. One way to accomplish this is to equip the system with such a devices as a Card Reader/Cashless Device “Cashless Device”; where the card reader reads the information from the card and transmits it to the Cashless Device; the Cashless Device connects (usually wirelessly) with an outside device located in what is called a Clearing House. The Clearing house validates the card and communicates to the Cashless Device the available credit. Directly or through an Interface Adapter the Cashless Device communicates the availability of credit to the VMC, and the VMC will complete the vend cycle.

Known vending machines such as those disclosed in U.S. Pat. No. Des. 294,718, U.S. Pat. No. Des. 297,740 and U.S. Pat. No. 5,955,718, 7,222,748, 7,222,749 typically include a vending machine selection panel having a plurality of selection buttons, a coin inlet slot, a display, a sold out indicator light, a use correct change indicator light, and a coin return lever. Many such vending machines also include a covered bill acceptor slot and a point-of-sale window located near the selection panel. The cover can be removed to facilitate the installation of a bill acceptor, the front face of which typically encompasses the entire bill acceptor slot.

With the increased acceptance of card technologies, in some vending machine applications it is desirable to include a card reader to provide the customer with a variety of purchasing methods. It is known to install a card reader rather than a bill acceptor in the bill acceptor slot of the vending machine. However, installing both devices would be more convenient. Bill acceptors like the one presented in FIG. 2 accomplishes tasks, receiving bills through the inlet 20 and allowing the swiping of a credit card through channel 30. Both types of credits are transmitted to the VMC.

The VMC coordinates other vending machine functions related to customer display and messages, power management and environmental conditions for the product inside the vendor and the vendor appearance including lights and product illumination, etc. FIGS. 4, 5, 6, 7, 8, 9, and 10 show how the VMC connects and coordinates the credit accepting devices, the selection means, and the display and vending means. A complete description of these functions is provided in U.S. Provisional Patent Application Ser. No. 61/515,219 entitled “Method and Apparatus for controlling the operation of a Vending machine equipped with cash and cashless credit accepting devices”, filed Aug. 4, 2011, The contents of said application are incorporated herein by reference.

One will understand that the diversity of vending machines with a different multitude of functions related to credit acceptance, product dispensing and other functions made the number of Vending Machine Controller types quite large. U.S. Pat. No. 5,955,718 describes the details of such VMC as shown in FIG. 11. Accordingly, it is desirable and advantageous to provide a modular Vending Machine Controller easy to reconfigure to facilitate retrofit or installation into any existing vending machines. It is also desirable to provide the VMC with a modular design that will allow the controller to meet the space requirements of such vending machines.

### BRIEF DESCRIPTION OF THE DRAWINGS

FIG. 1 is a block diagram illustration of a Vending Machine equipped with a Coin Changer, a Bill Validator, a Card Reader a large Display and an improved Vending Machine Controller, according to an embodiment of the present invention;

FIG. 2 is a perspective view of a Bill Validator-Dispenser and Card Reader according to an embodiment of the present invention;

FIG. 3 is a schematic view of a Coin Changer according to an embodiment of the present invention;

FIG. 4 is a block diagram illustration of a Vending Machine Controller of the Prior Art connecting with a multiple coin tubes Coin Changer, a Bill Validator-Dispenser, a Card Reader and a Cashless Device for cashless and telemetry functions installed within a vending machine;

FIG. 5 is a block diagram illustration of a Vending Machine Controller of the Prior Art connecting with a multiple coin tubes Coin Changer, a Bill Validator-Dispenser, a Card Reader and a Cashless Device for cashless and telemetry functions, installed within a vending machine using an Interface Adapter;

FIG. 6 is a block diagram illustration of a Vending Machine Controller of the Prior Art connecting with a multiple coin tubes Coin Changer, a Bill Validator, a Bill Dispenser, a Card Reader and a Cashless Device for cashless and telemetry functions, installed within a vending machine using an Interface Adapter;

FIG. 7 is a block diagram illustration of a Vending Machine Controller of the Prior Art connecting with a multiple currency system with the VMC performing the conversion and holding the remainder credit, according to an embodiment of the present invention;

FIG. 8 is a block diagram illustration of a Vending Machine Controller of the Prior Art connecting with a multiple currency system with the Coin Changer performing the conversion and holding the remainder credit, according to another embodiment of the present invention;

FIG. 9 is a block diagram illustration of a Vending Machine Controller of the Prior Art connecting with a multiple currency system with the Bill Validator-Dispenser performing the conversion and holding the remainder credit, according to yet another embodiment of the present invention;

FIG. 10 is a block diagram illustration of a Vending Machine Controller of the Prior Art connecting with a multiple currency system with the Interface Adepter performing the conversion and holding the remainder credit, according to yet another embodiment of the present invention;

FIG. 11 is a block diagram illustration of Prior art Vending Machines and Vending Machines Controllers as per description available in the U.S. Pat. No. 5,955,718

FIG. 12 is a block diagram illustration of a Vending Machine Controller with modular design, with integrated cashless/telemetry function, connecting to a Customer Interface Display and other blocks, according to an embodiment of the present invention.

FIG. 13 is a picture of the Vending Machine Controller showing some of the modules, the interconnections and interfaces, according to an embodiment of the present invention.

FIG. 14 is a picture from another angle showing the Vending Machine Controller and some of the modules, the interconnections and interfaces, according to an embodiment of the present invention.

FIG. 15 is a picture from yet another angle of the Vending Machine Controller showing some of the modules, the interconnections and interfaces, according to an embodiment of the present invention.

FIG. 16 is a picture of the Vending Machine Controller form the front side showing the Customer Interface Display, the interconnections to the VMC, according to an embodiment of the present invention.

FIG. 17 is a drawing showing the VMC modular construction, Board Assembly view, according to an embodiment of the present invention.

FIG. 18 is a schematic representation of the Vending Machine Controller showing the modular construction, according to an embodiment of the present invention.

FIG. 19 is a generalized diagram of the different LCD-TFD display states, according to an embodiment of the present invention.

FIG. 20 shows the LCD-TFD display during the Initialization Mode, according to an embodiment of the present invention.

FIG. 21 shows the LCD-TFD display during the Sales Mode of operation, according to an embodiment of the present invention.

FIG. 22 shows the LCD-TFD display after a product was selected, according to an embodiment of the present invention.

FIG. 23 shows the LCD-TFD display during the vending of a product, according to an embodiment of the present invention.

FIGS. 24 and 25 shows the LCD-TFD display when a selected product could not be vended, according to an embodiment of the present invention.

FIG. 26 shows another look of the LCD-TFD display during the vending of a product, according to an embodiment of the present invention.

FIGS. 27 and 28 shows the LCD-TFD display with customer product selection keys, according to an embodiment of the present invention.

FIG. 29 shows a blurred LCD-TFD display during low temperature environmental condition of the vendor, according to an embodiment of the present invention.

FIG. 30 shows a LCD-TFD display with non-moving content selected during low temperature environmental condition of the vendor, according to an embodiment of the present invention.

FIG. 31 shows a LCD-TFD display with its content affected by the outside bright light condition the vendor, according to an embodiment of the present invention.

FIG. 32 shows a LCD-TFD when the VMC detects the bright light condition and the screen is replaced with the one that is much less washed out.

### DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

An innovative Vending Machine Controller (“VMC”) is the subject of this invention. In the preferred embodiment of the invention, the VMC is capable of implementing advanced vending machine features as desired for particular applications just by easily changing one or some of the modules. Additionally, the VMC is capable of controlling a customer display with messages related to the conditions, environmental or otherwise for the vended product, etc. The VMC is also capable of communicating with a Card Reader which communicates with an outside clearing house for implementing cashless transactions and telemetry functions.

The usage of vending machines capable of accepting credit via credit cards while paying out change from coin tubes and from a Bill Validator equipped with a Dispenser box is ever increasing. The usage of cashless devices and the need of telemetry functions necessitate communications between the vending machine and external clearing house or similar entities.

It is a further object of this invention to provide an improvement to the Vending Machine Controller that will allow communicating to a mobile device, e.g. a cellular that a particular product that the mobile is searching for is available and at what price.

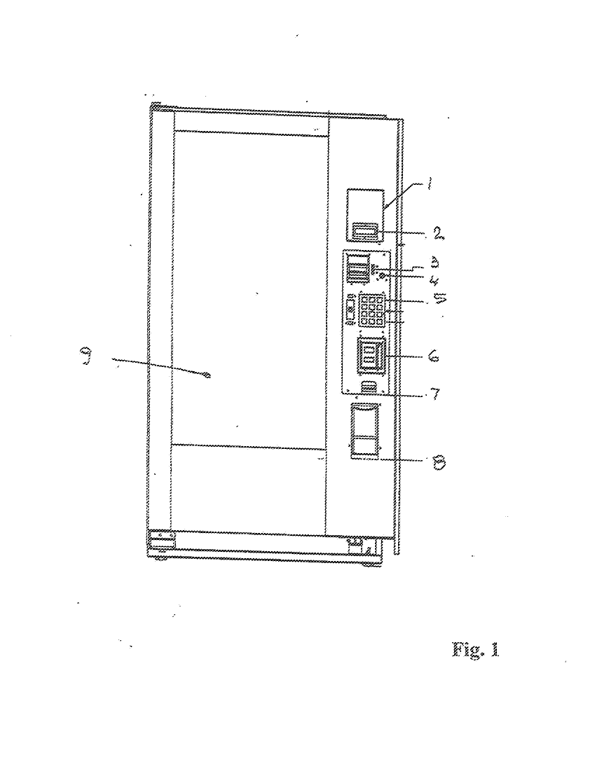

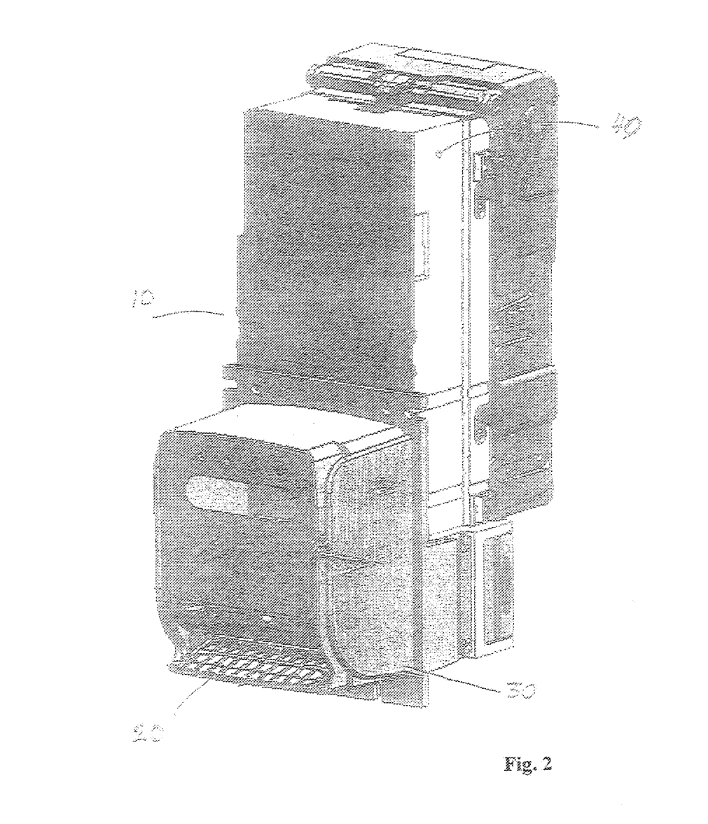

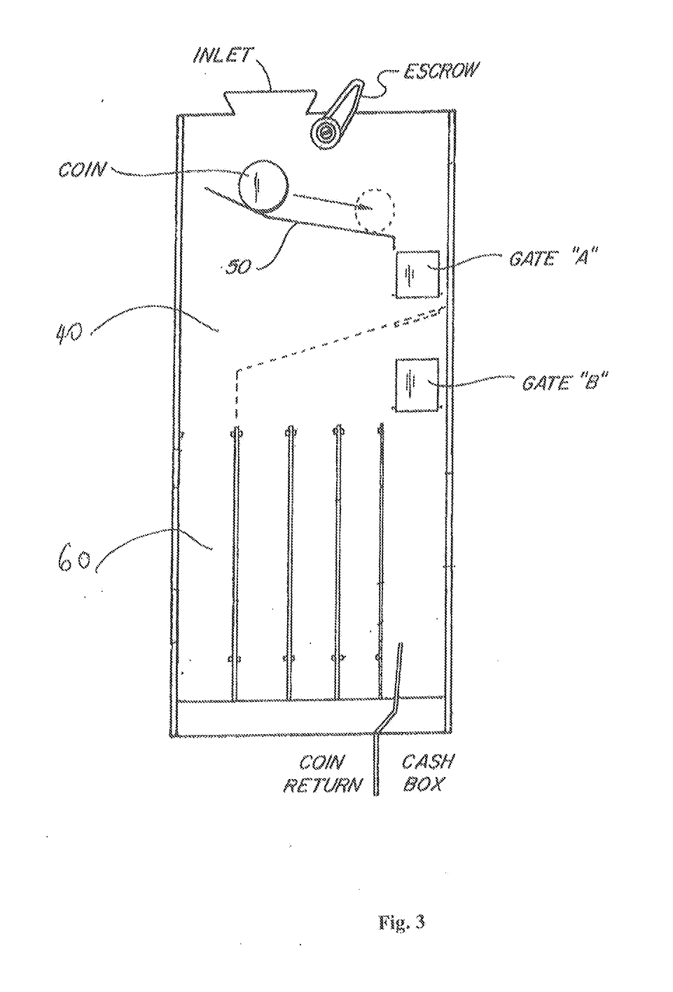

Referring now by reference numerals to the drawings and first to FIGS. 1, 2, 3 and 4, it will be understood that a Vending Machine 9 has on the right side a panel holding customer accessible devices; the devices allows the customer to establish a credit, to select a product, to view data on a display, to receive a product and change if appropriate. In FIG. 1, 1 is the a large Customer Interface Display that could be replaced by a small one 2; 3 is a coin insert slot and 4 is a cash return button for cancelling a transaction; 5 is a product selection keypad; 6 is a bill Validator/card reader inserts better viewed in FIG. 2; 7 is a change return cup and 8 is the product receiving port. In FIG. 2 a Bill Validator 10 is shown in conjunction with a Dispenser or Recycler module 40, and a Card Reader 30; the Bill Validator 10 is being removably attached to the vending machine. A Card Reader 20 is removably or fixed attached to the Bill Validator 10. In FIG. 3, Coin Changer 40 has a coin acceptor portion 50 and multiple tubes of multiple denominations 60. The Coin Changer 40 function is to receive, validate and communicate to the VMC the value of accepted coins. Accepted coins are deposited in tubes for future use as change. The Bill Validator-Dispenser 10 validates accepted bills and deposits them in Dispenser or Recycler box for future use as change. Earlier versions of Bill Validator devices had no recycler box so they will only validate the notes and transmit their value to the VMC. In some versions the Dispenser or Recycler Box is remotely located versus the Bill Validator and could only be manually loaded with bills. The Card Reader 20 located on the outside portion of the Bill Validator Mask; a card swiping channel located on the right side of the Mask has a card reading head located in the channel and not shown; circuitry and interfaces are located behind the mask and not shown. The Card Reader 20 reads the information on the card, when the card is swiped through the channel and transmits it to a Cashless Device. Some Card readers are equipped with a wireless interface that allows the reader to read information from the card by bringing the card in the proximity of the reader. Other card readers are equipped with a set of electrical contacts and reads information from a card when the card's corresponding electrical contacts touch the reader contacts.

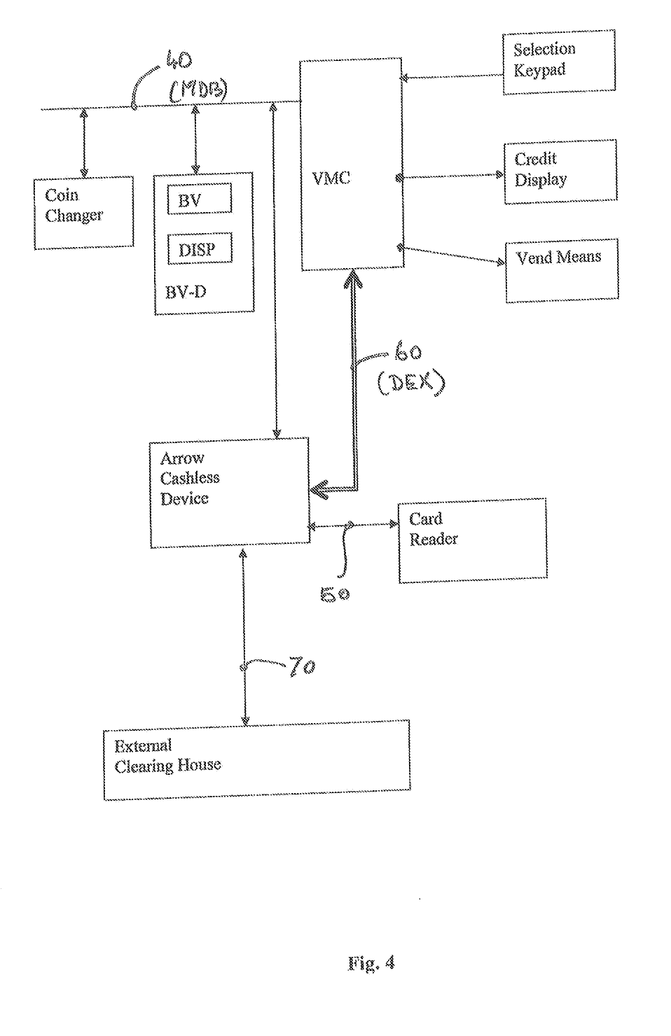

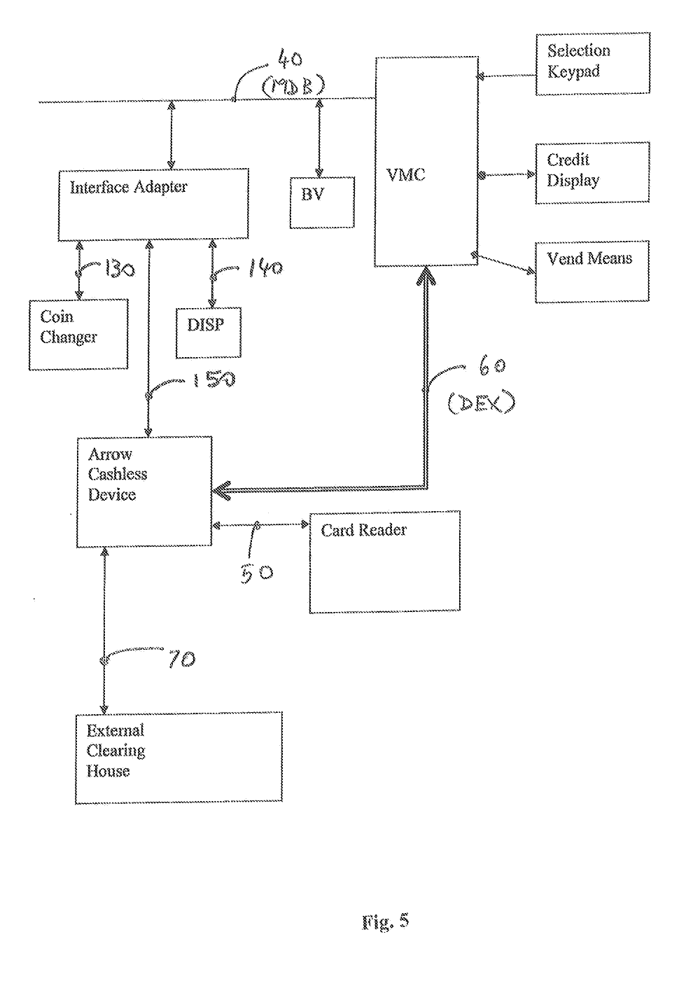

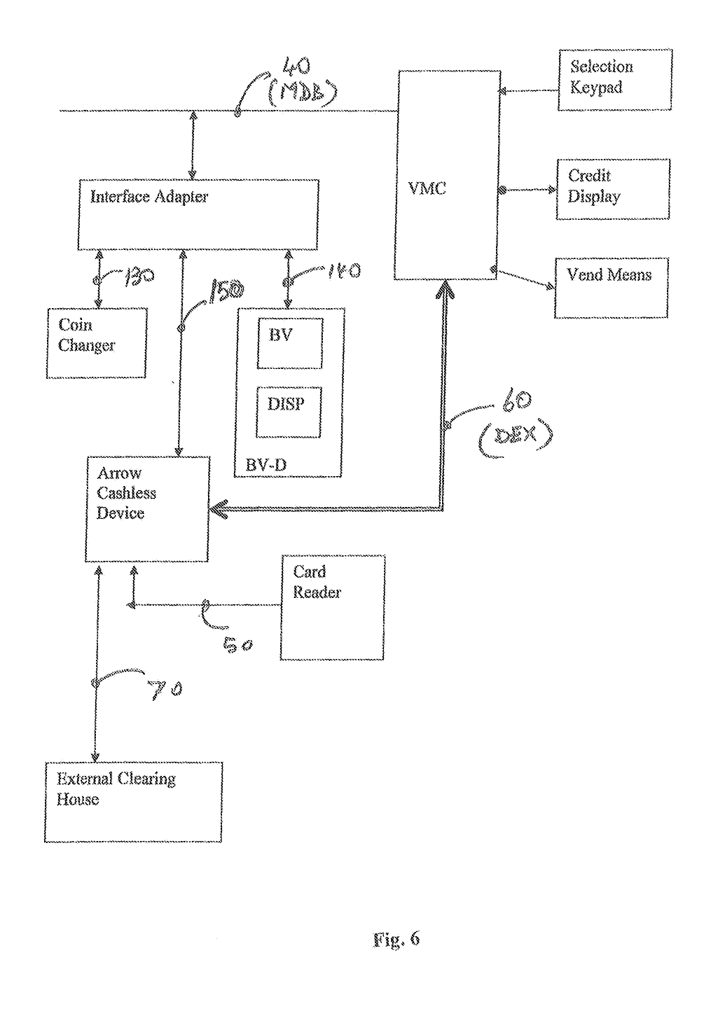

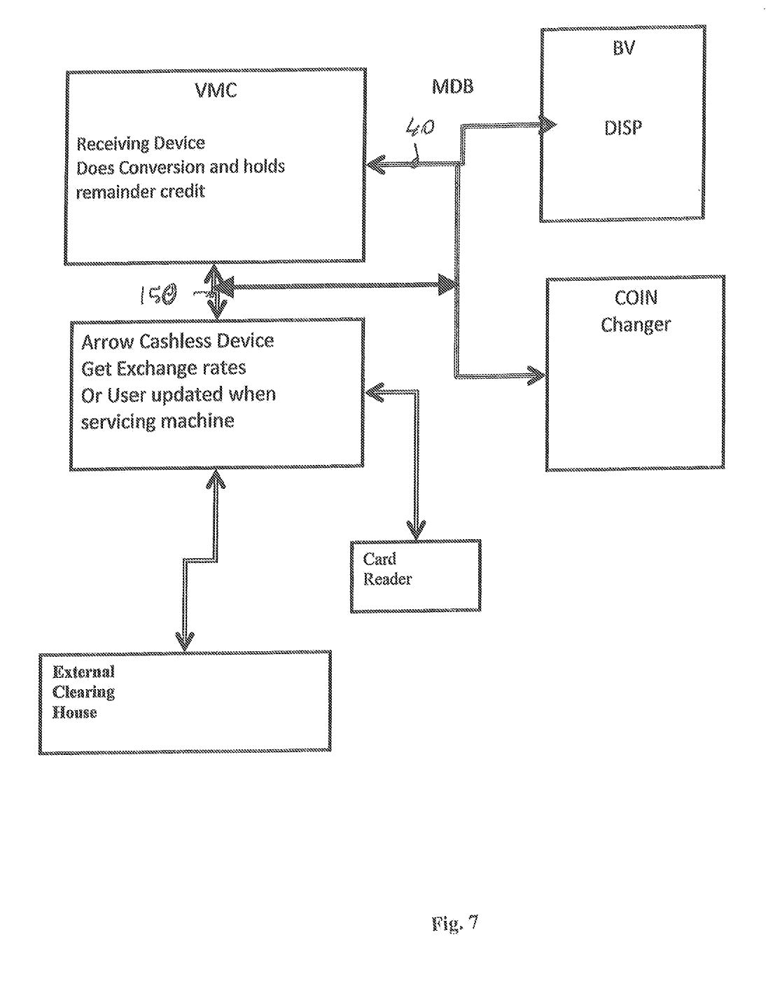

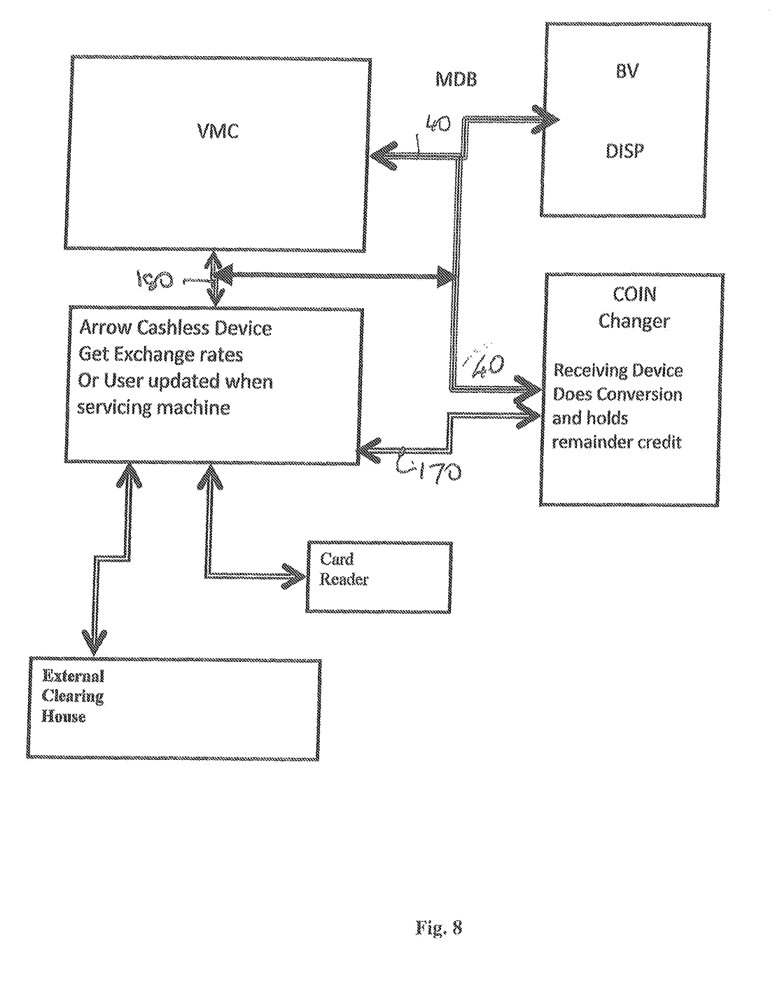

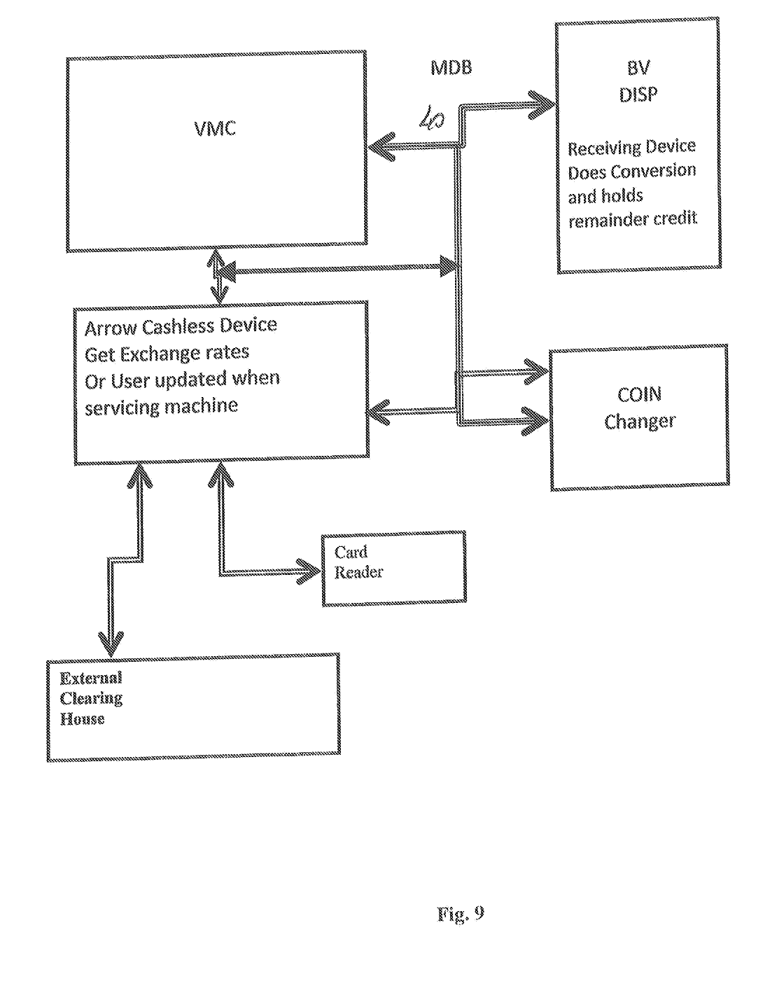

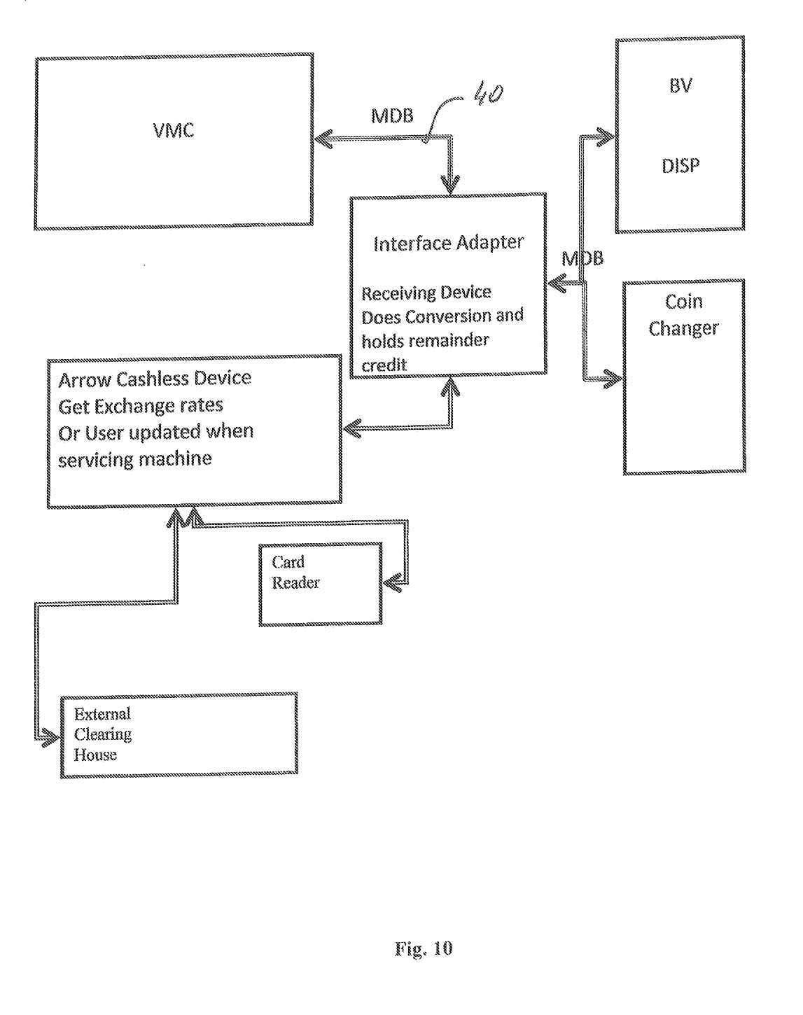

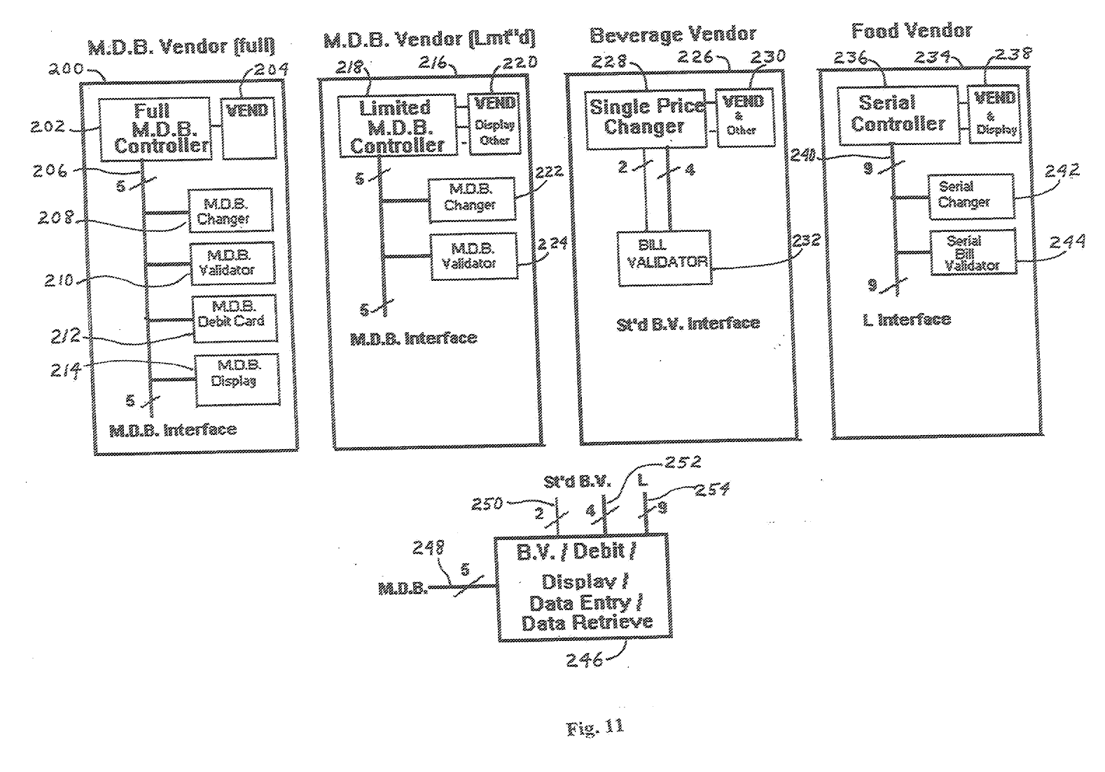

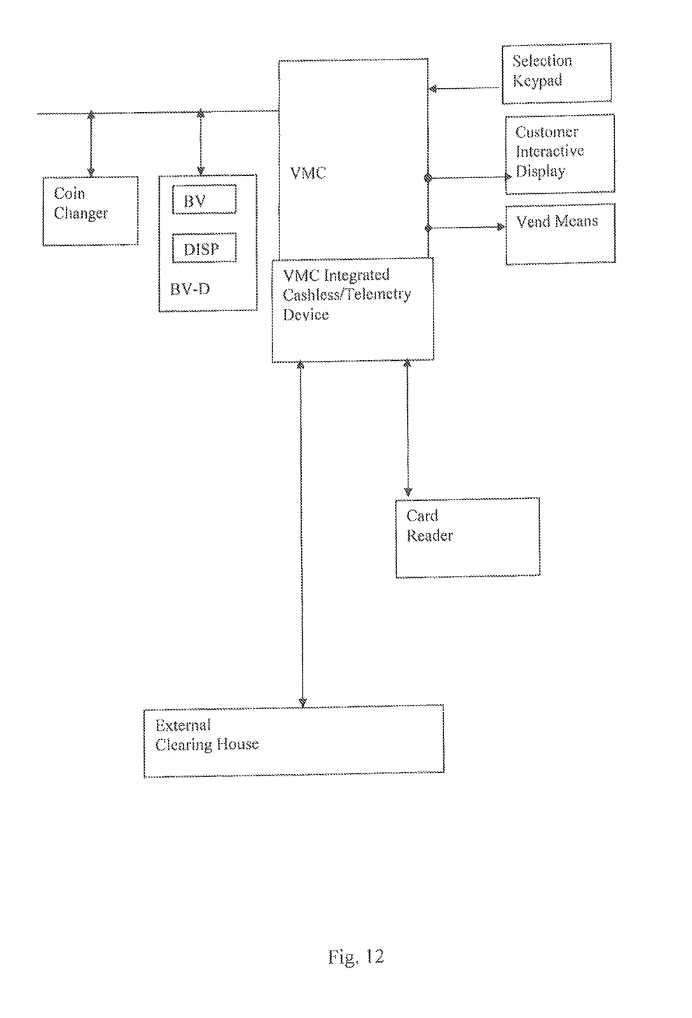

Vending Machine 9 equipped with the above described Bill Validator-Dispenser, Card Reader, Coin Changer, has installed inside and not visible a Vending Machine Controller, VMC, and other modules as described schematically in FIGS. 4 to 11 (prior art) or FIG. 12 for the current invention. The customer selects a product using the keypad selection 5 and, after the “vend cycle” is completed, retrieves the product from the port 8. If change is due it will be available at change cup 7. Change to be paid to the customer it is available in the form of coins stored in the coin tubes of the Coin Changer or bills stored in the Dispenser (Recycler) Box. The VMC calculates the change and controls the payout of change from both the Changer and The Recycler. The changer receives and validates coins and communicates the credit to the VMC; it also deposits the accepted coins in tubes and communicates the status of the tubes to the VMC. The Bill Validator in this installation receives and validates currency notes and communicates their values to the VMC. The Card Reader reads information from the Card and sends it to a Cashless Device and from there to the VMC, in the prior art cases, or directly to the VMC in the context of this invention per diagram in FIG. 12. In the prior art case, the Cashless Device communicates with a Clearing House to obtain credit approval and communicates the credit to the VMC. In the context of the present invention, the VMC obtains credit approval from the External Clearing House itself.

Referring to FIG. 4, a Coin Changer with multiple coin tubes is installed within a vending machine and it is in communication with the VMC via a Serial Bus 40 (e.g. MDB Buss); the Bill Validator in this installation will only validate notes and send their values to the VMC via the same serial bus 40. The Bill Dispenser is part of the Bill Validator. The VMC calculates the change to be paid out and sends it to the Coin Changer via line 40; the Coin Changer pays back the change and reports the accomplished task back to the VMC using the same line 40. Similarly the VMC calculates any change to be paid out by the Bill Validator-Dispenser and sends the task to this device via line 40; the Bill Validator-Dispenser pays back the change and reports the accomplished task back to the VMC using the same line 40. The Card Reader sends card information to the Cashless Device via line 50; the Cashless Device validates the credit by communication with the External Clearing House via line 70 and communicates the result to the VMC vial line 40 (MDB). Other communications between the Cashless Device and the VMC are over the lines 60 (DEX); multiple parameters that define the state of the Vending machine, like inventory per brand and selection, cash available as change, number of vends, total accumulated cash, door openings, etc., are communicated on these lines 60 using the DEX/UCS protocol.

The Vending Machine Controller described in FIG. 12 controls all the other peripheral devices as well as the vending means; the peripheral devices, Coin Changer, Bill Validator-Dispenser, and Card Reader, validate and report credit, store and payback change; the Selection Keypad helps the customer to make a particular selection; the Customer Interface Display displays the credit and other current activities; the Vend Means transport the product to the customer retrieval port 8. VMC holds the product prices and it has means for allowing the Vending Machine operator to set or modify them; means for an operator to enter a VMS or service mode are provided; these means for could be a combination of key switches pressed in a predefined order on the Selection Keypad when the Vending Machine door is open or closed, or by pressing a separate switch located on the VMC or in its proximity. When the VMC is in this mode the operator could set up product vending prices per location, brand or in other order; similarly the operator could change the prices from an amount to another.

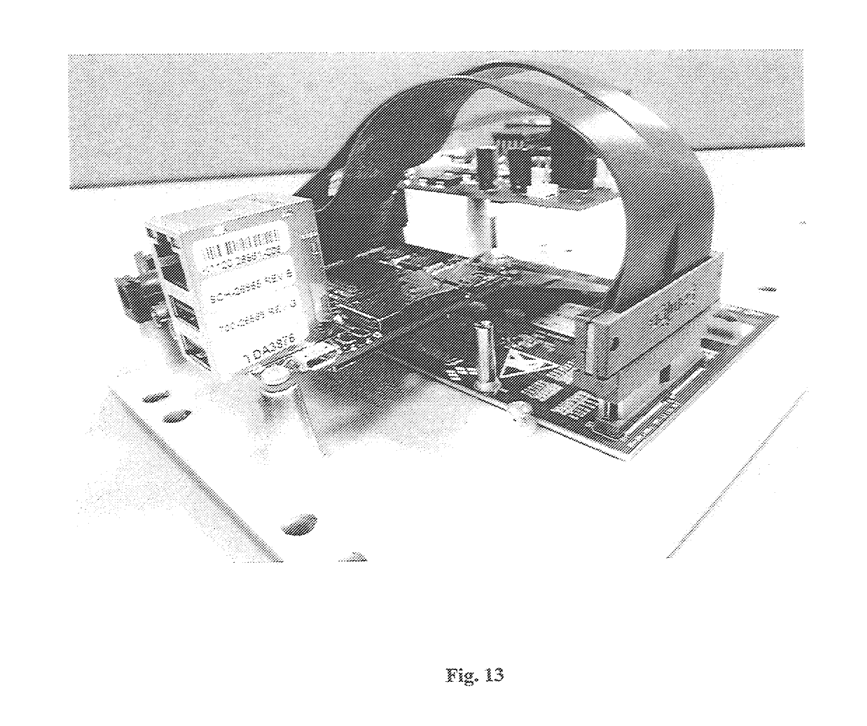

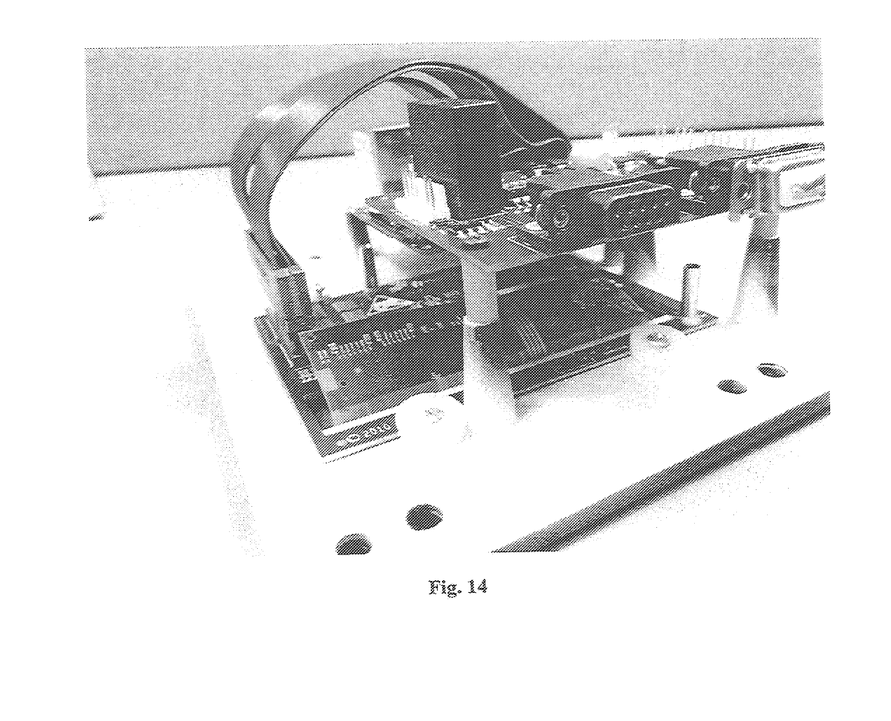

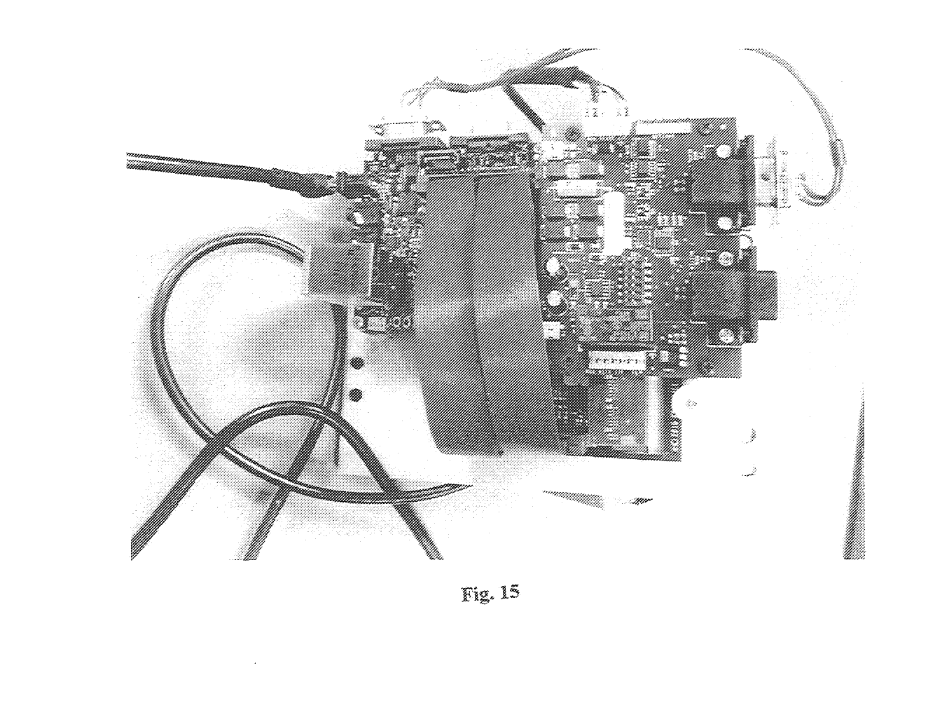

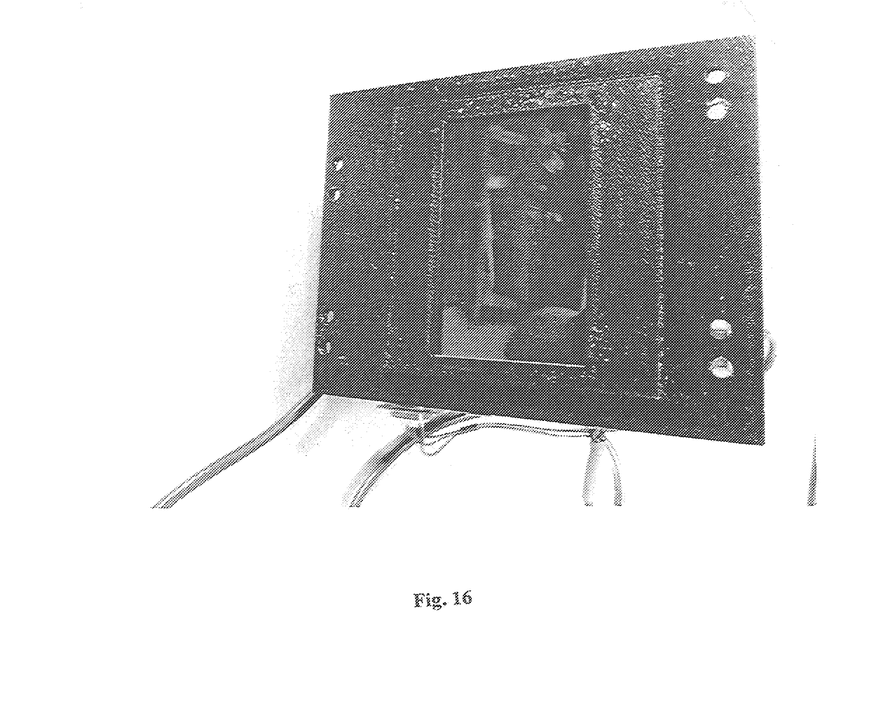

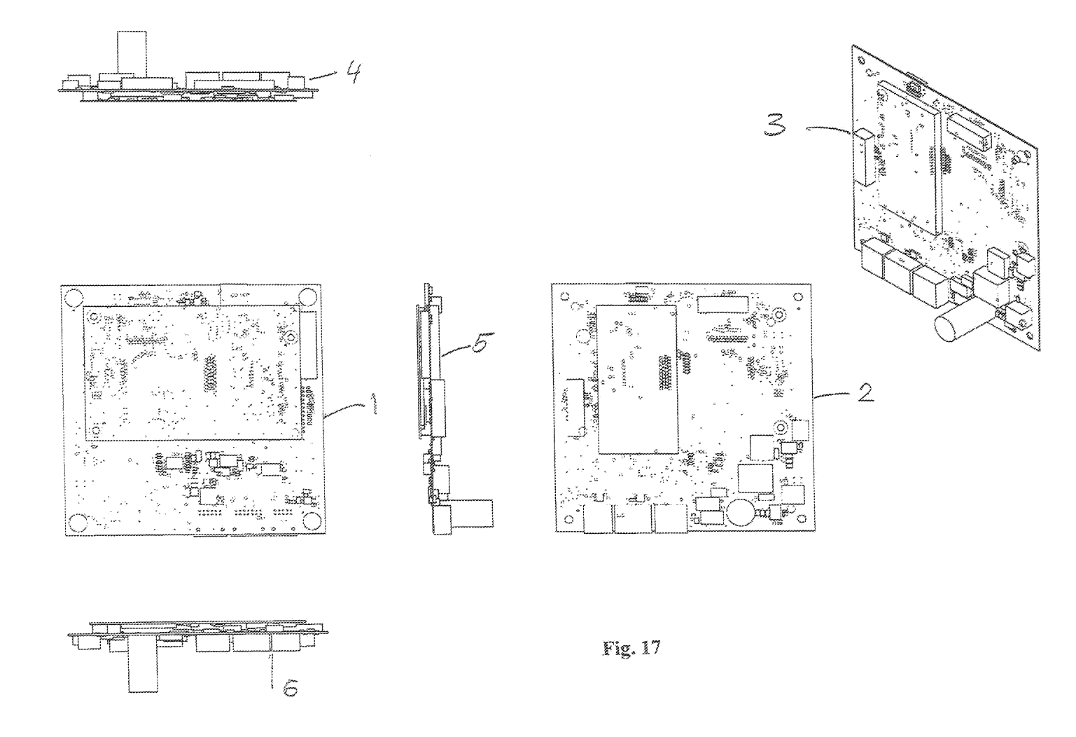

FIGS. 13, 14, 15, 16, 17 and 18 show the controller modular construction. FIGS. 13, 14, 15 and 16 are pictures of the Vending Machine Controller from multiple angles, showing modules, interconnections and Customer Interface Display; FIG. 17 is a PC Board description of the VMC assembly, where 1 is the front view, 2 is the back view, 3 is the isometric view, 4 is the top view, 5 is the side view and 6 is the bottom view.

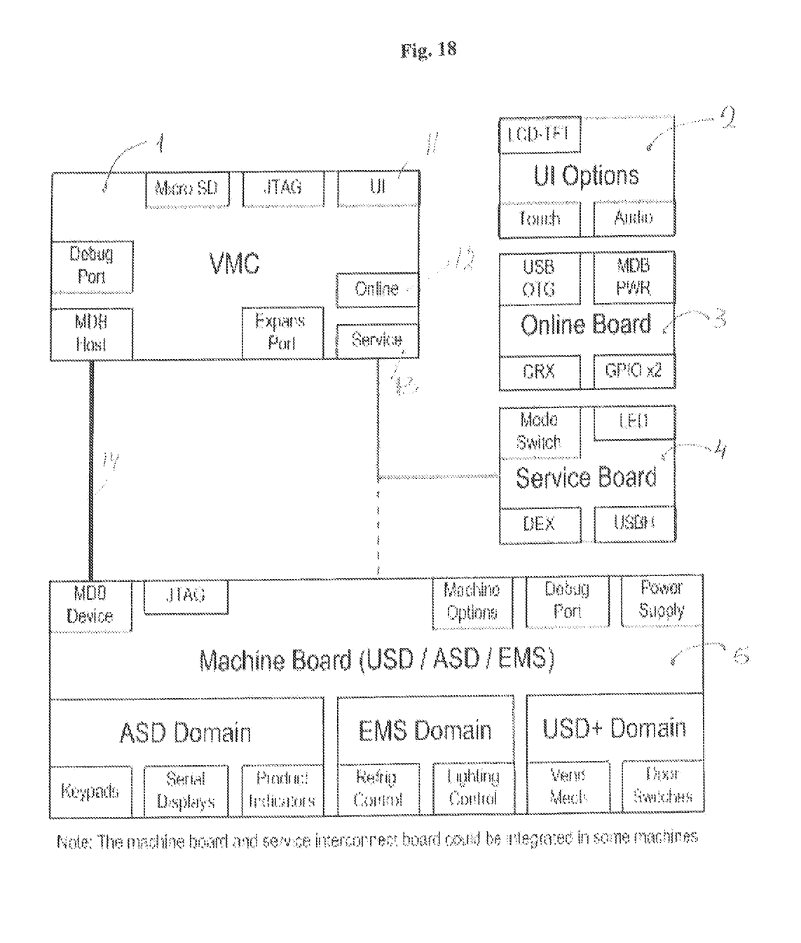

FIG. 18 is the module description diagram, where 1 is the Vending Machine Controller Base Board, Base Controller; 2 is the User Interface Options module Board; 3 is the Online connecting Board Module; 4 is the Service mode Board Module and 5 is the Vending Machine specific Board Module.

The Vending Machine Controller Base Board, Base Controller, is the main control board in the vending machine. The VMC collects and controls system actions via the MDB bus. The MDB bus connects to the Base Board via the MDB Host Interface. The Base board communicates with different modules via ports, as follows: with the user Interface Module via the 11, User Interface Port; with the Online board Module via the 12, Online Port; with the Service Module via the 13, the Service Port and with the Machine Module via the 14, MDB bus and sometimes via the 13. The core hardware of the base board is a microcontroller, VMC, the Freescale i.MX283 processor running at 400+ MHz. The memory of the system is located on the same board for a total of 128 MB of DDR2 memory and 128 MB of NAND. When the User Interface module is present the controller first detects if the TFT type Customer Interface Display is available and, if it is present, communicates data for displaying both product information and high-end videos advertizing. The communication protocol between the Base Board and the User Interface Module equipped with a TFT Customer Interface Display is WVGA, 480×800 pixels, displays in either landscape or portrait mode with two display sizes: a 4.3″ and a 7″. The 7″ display is oriented in the vending machine in a portrait orientation, e.g. taller than wide. If a 4.3″ display is used to retrofit applications where a 741 screen would not fit in location 1 FIG. 1 of the Vending Machine, the 4.3″ display is oriented in a landscape mode.

The Base Controller uses a direct-drive CMOS RGB interface to control the TFT Customer Interface Display via the Port 11.

The Base Controller video support uses the baseline profile of the H.264 specification and files encoded as shown below:
Codec: H.264
Profile: Baseline
Resolution: 432×240 (WQVGA)
Framerate: 24 fps maximum
   The Base Controller Audio support consists of AAC and MP3 encodings.

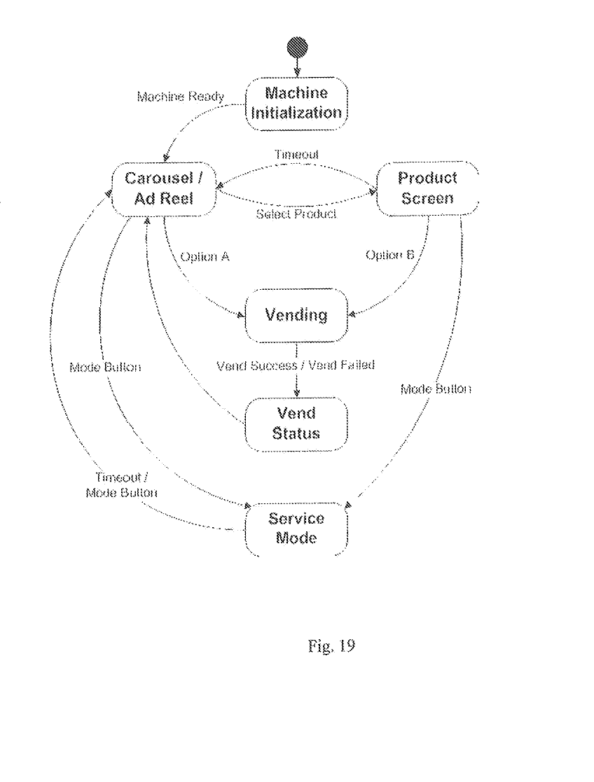

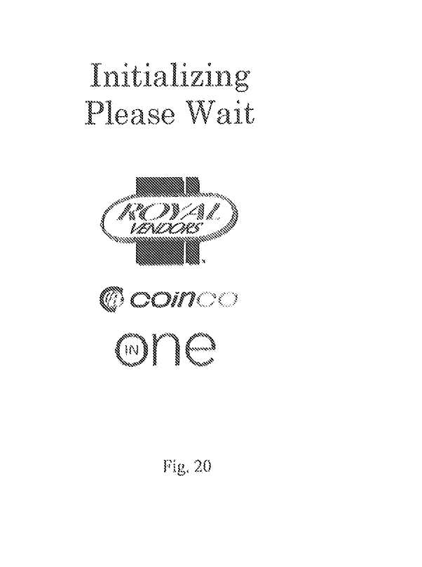

The Vending Machine Controller has a Machine Initialization Mode, a Vending Mode and a Service Mode. The Customer Interface Display appears differently in every Mode. A generalized diagram of the different display states is shown in FIG. 19. During the Initialization Mode the VMC initialize file systems and get all services started; during this time the Display shows like in FIG. 20 to prevent operators from mistakenly assuming the controller is inoperable or the machine is locked-up.

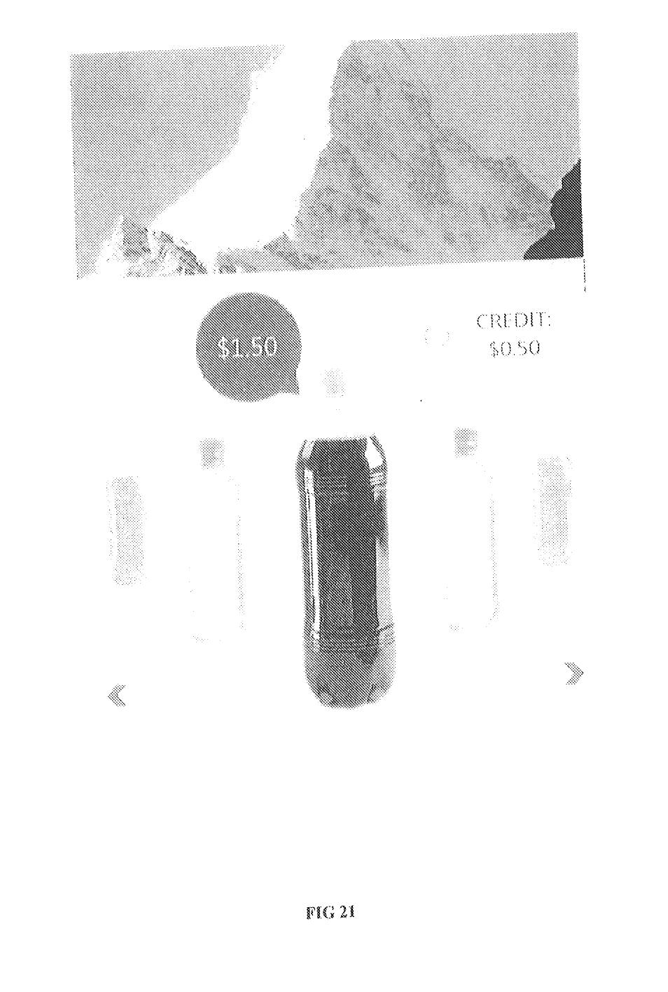

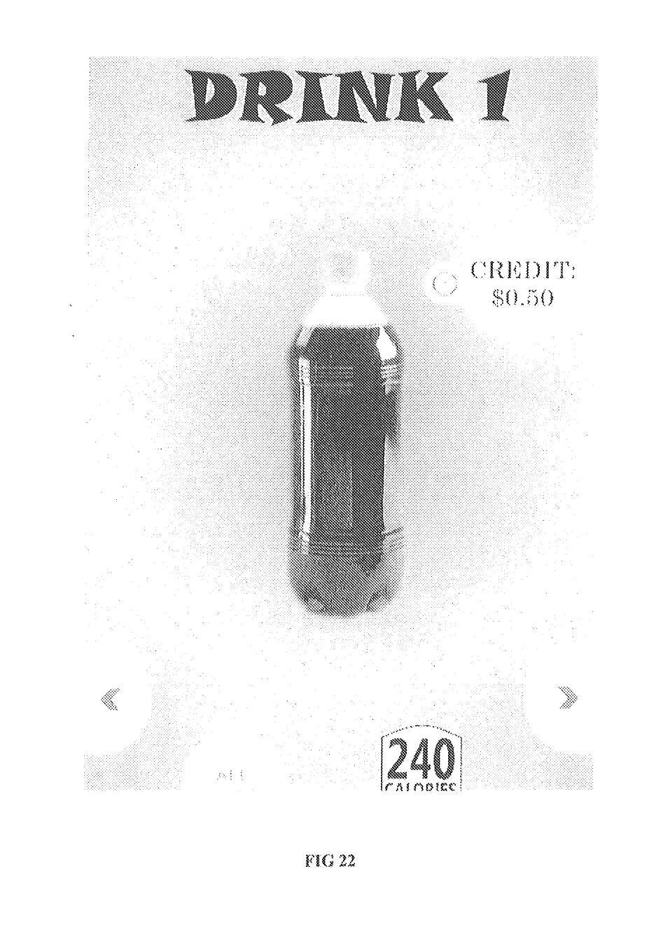

In the Sales mode the customer could insert money or establish credit via the credit card reader, select and vend a product. In this state the Display shows like in FIG. 21. There are three regions to the screen. The top portion of the screen is a rich content display region. This region displays product advertising (video files or images), location-specific information, or general advertising/rich media content. The middle region of the screen is the product carousel. The carousel area allows the consumer to see all the products in the vending machine, view the prices, and view current credit information. The product carousel is used to select a product to view the product information. The banner area at the bottom of the screen provides links to special programs to register or view promotions, or log into an account in order to spend previously accumulated points. After periods of inactivity, the carousel will start rotating. This both allows the consumer to see the products in the machine, but also creates motion to draw the attention of consumers. The carousel will be updated with the current product status. If a product is sold-out the price bubble will display “Sold Out” instead of the current price. Similarly if the product is blocked, the bubble will be updated to show a “Denied” message. When a product is selected the Display will show a Product Screen as shown in FIG. 22. This screen can be reached either by pressing the focused product from the carousel screen or by pressing a specific selection button on machines with selection buttons. This screen is the location where the consumer can view the nutritional information for the product. When they put in enough credit confirm their selection a buy button will appear allowing the customer to confirm their selection and dispense a product. The left and right buttons allow navigation between the product pages or the consumer may press the “All Products” button and return to the Carousel.

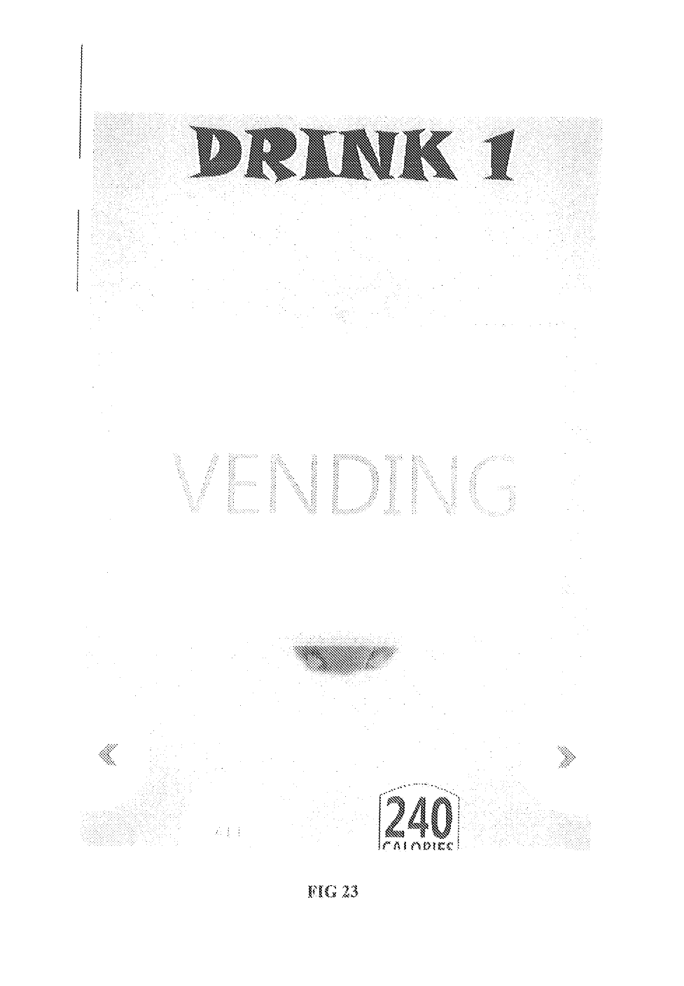

FIG. 23 shows the Vending page that is displayed when the consumer requested a product to be dispensed and the VMC has determined that all preconditions have been met to allow the operation. It will be displayed as long as the VMC and machine board are attempting to deliver a product.

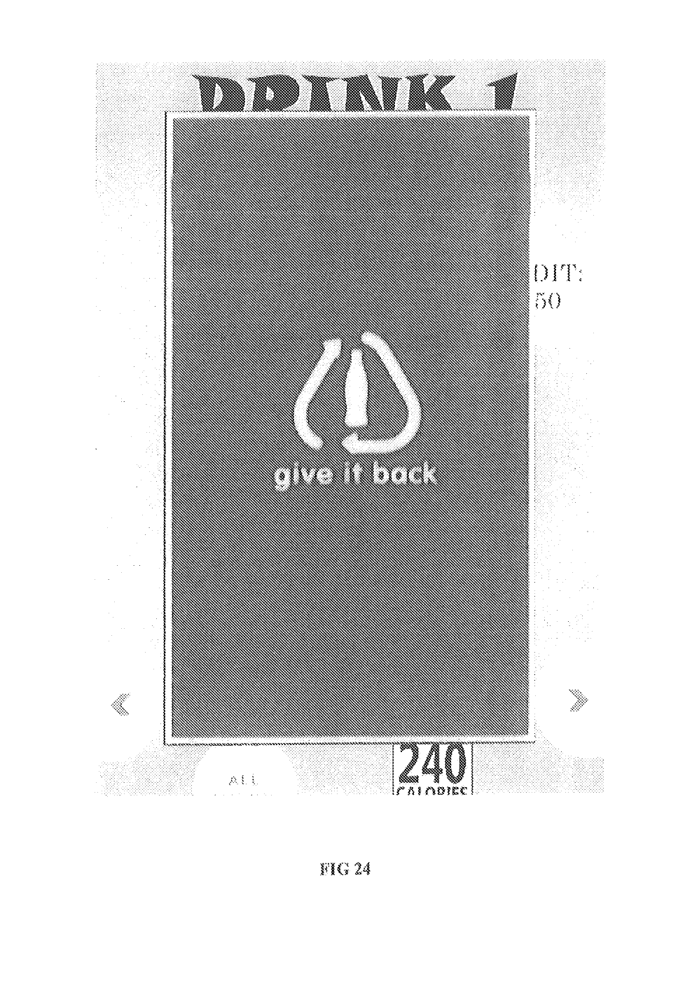

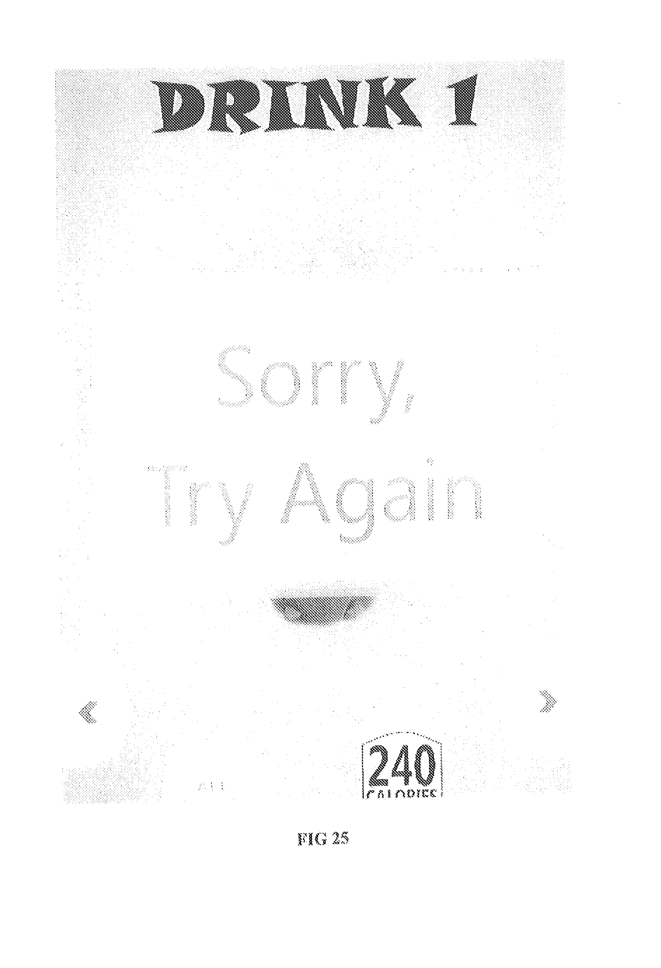

FIGS. 24 and 25, show the Vend status page that is displayed anytime the VMC has displayed the vending screen. It will be used to show a “Thank You” message upon successful completion of a vend cycle or display one of the “try again” messages if a product was jammed or sold-out. Examples of each are shown below. These messages are shown for 3 seconds before the system returns to the carousel.

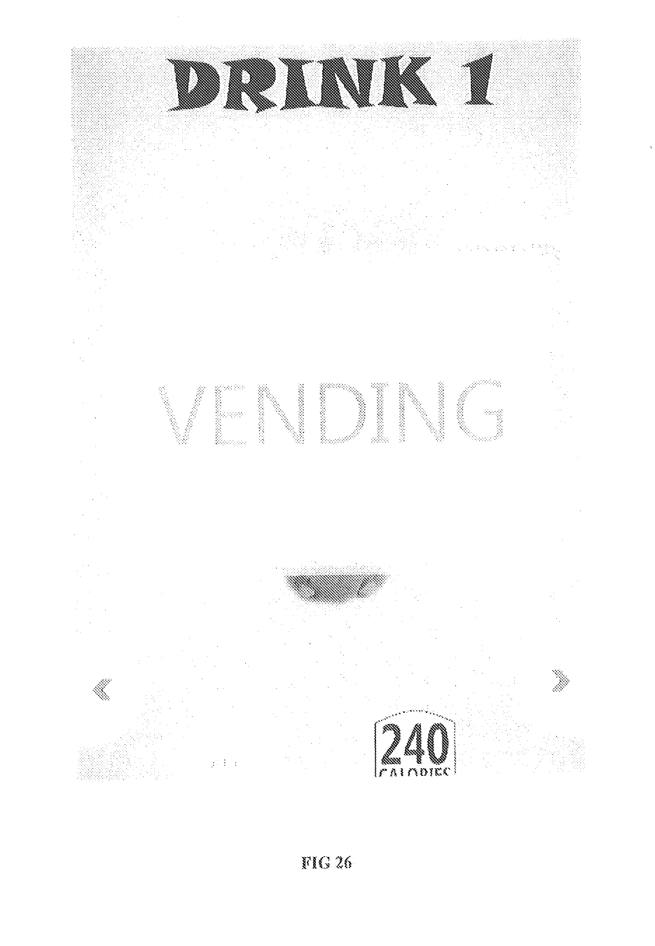

During the vend operation the Display shows like in FIG. 26.

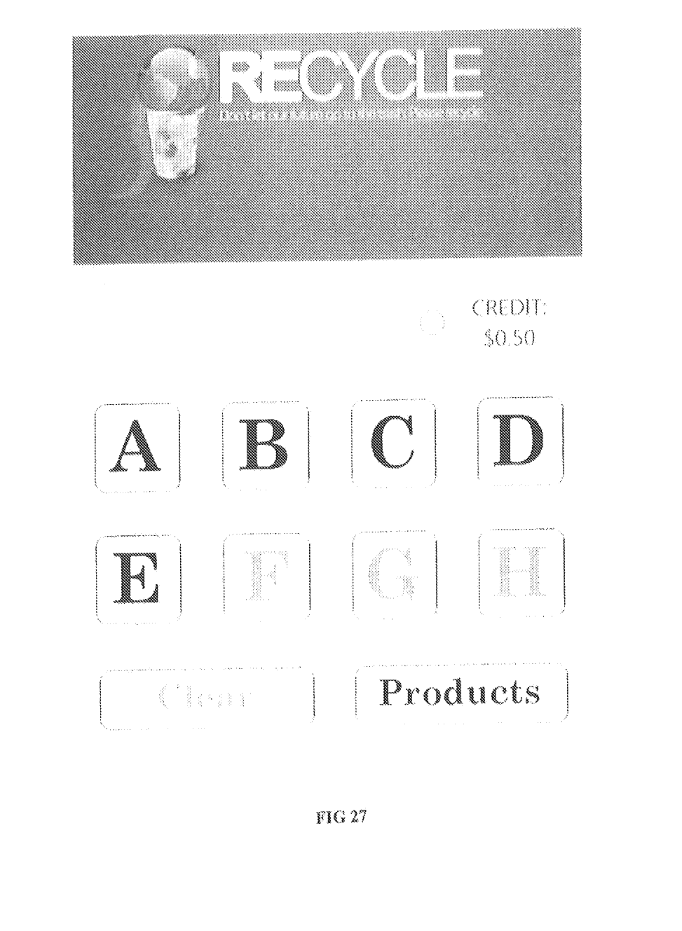

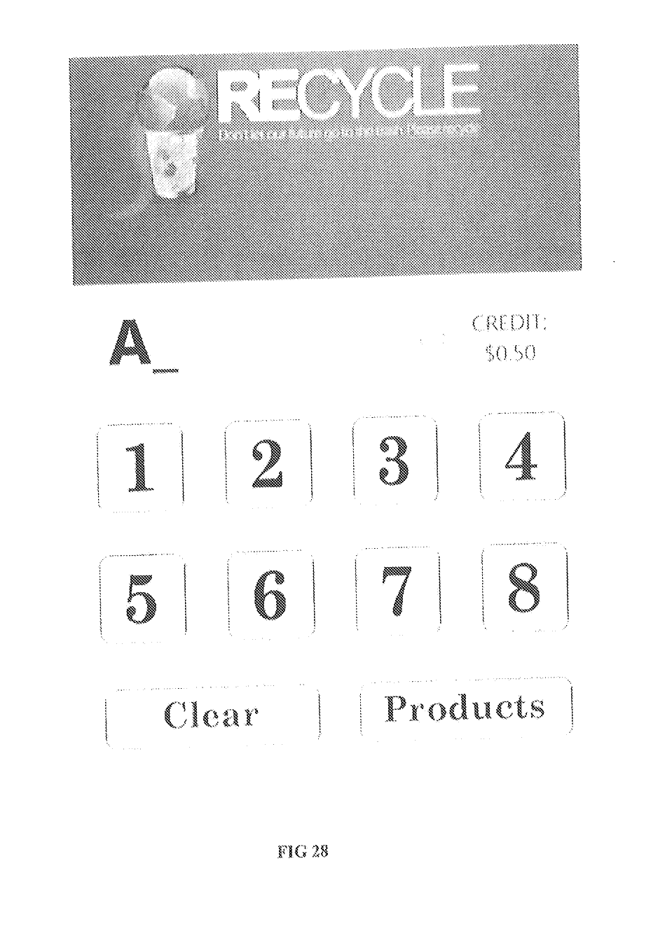

Glass front vending machines typically have operated differently than a closed-front vendors in that instead of pressing a selection button tied to a particular product, the consumer keys in the location from which a product shall be dispensed. The Vending Machine Controller easily could adapt the styles as the TFT is located on a separate module. The Display will show as in FIG. 27 and FIG. 28.

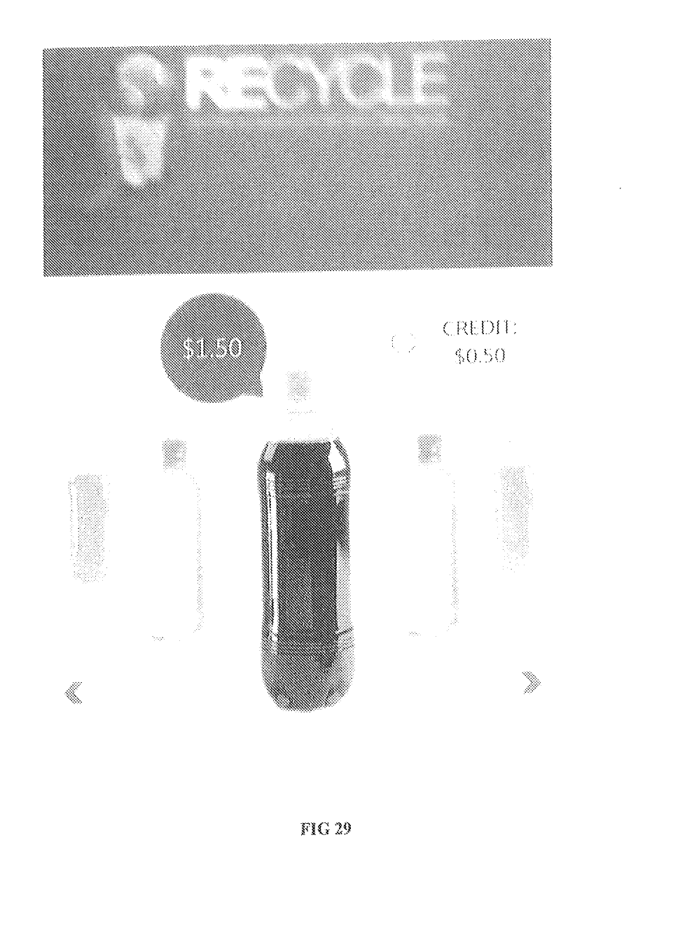

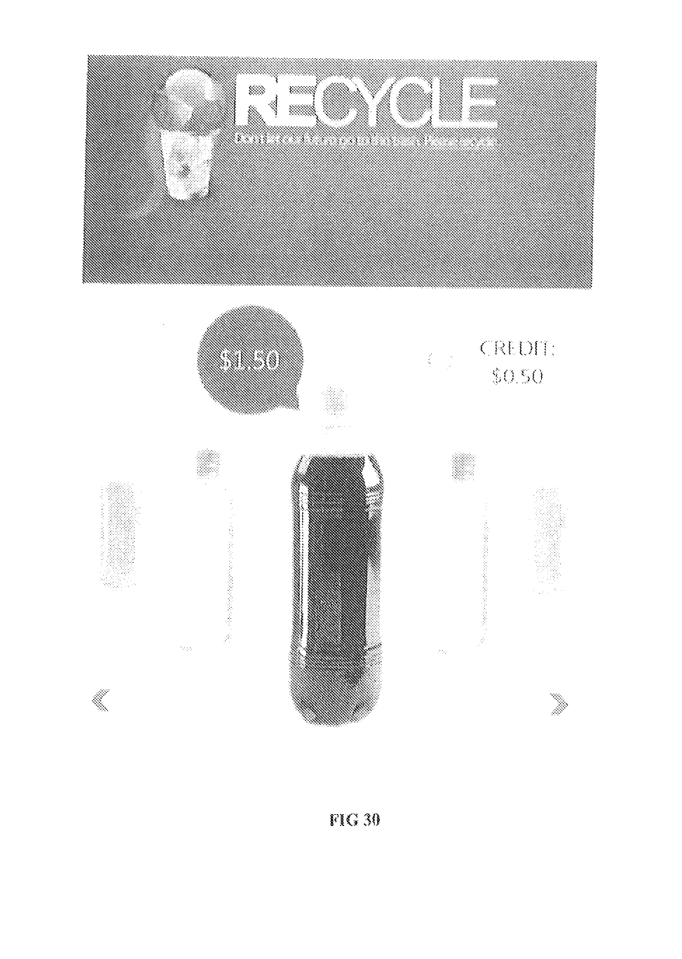

The VMC has sensors to sense key parameters of the environment. These include outside air temperature and brightness. The feedback from these sensors is used to modify the screens displayed to the consumer to maximize visibility and aesthetics of the system. Regardless of technology, the response time of all LCD screens will increase as the temperature decreases. This could cause undesirable performance of the display, including motion in videos causing a blur or completely illegible displays. FIG. 29 shows a blurred display. The temperature sensors in the VMC allow the system to switch to either a set of video content which has been flagged for acceptable display behavior at low temperature or display non-moving content such as in FIG. 30. A secondary use of the temperature sensors is to switch to special content when the temperature drops above/below pre-set thresholds. One examples of this is switching to a winter scenes on the display when the temperature drops below freezing. A second example is to switch from a normal content to content mentioning how those products help beat the heat once the temperature exceeds, for example, 95 degrees.

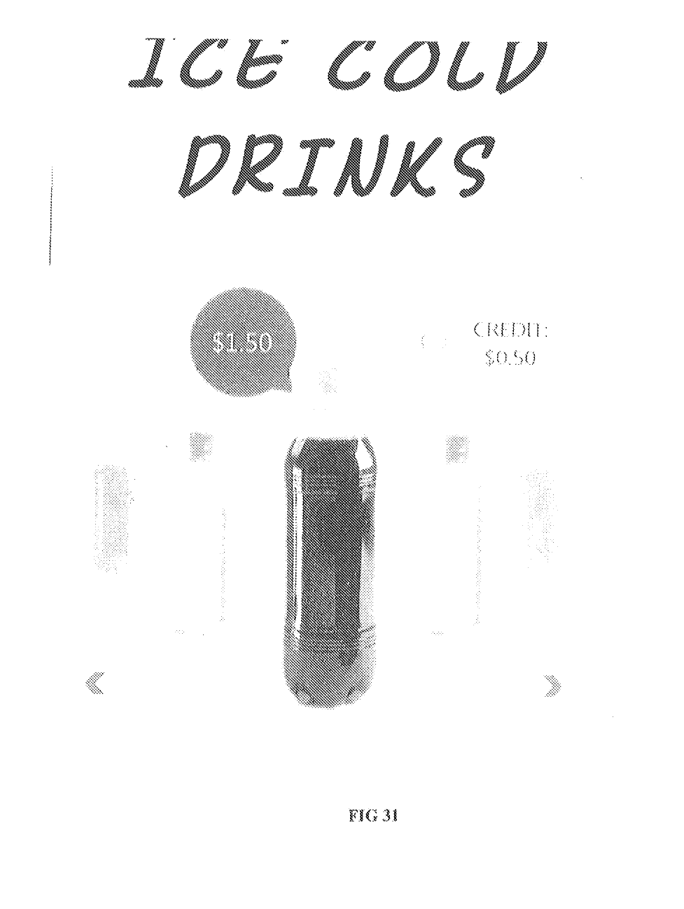

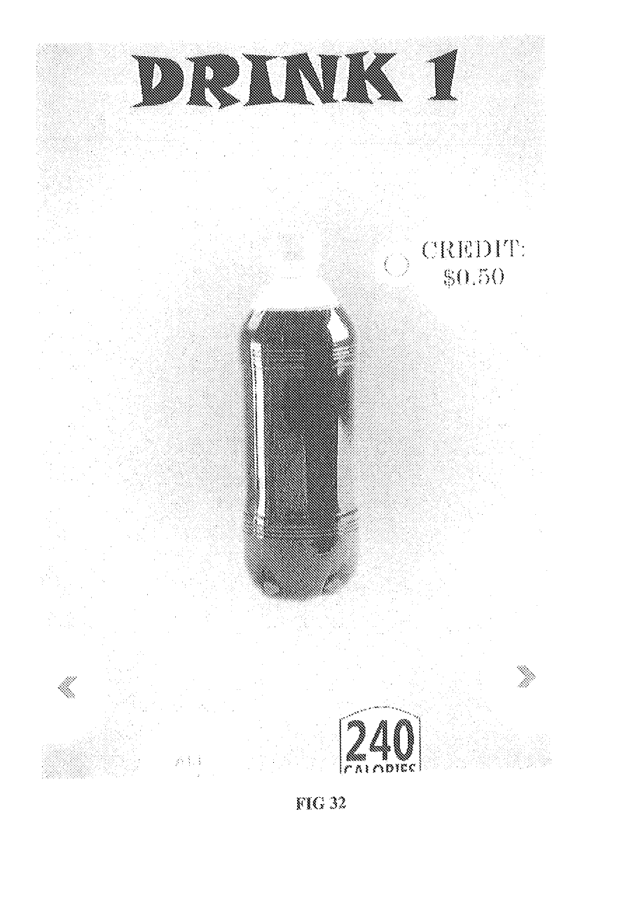

The VMC uses a brightness sensor to monitor the outside brightness; accordingly the VMC controls and changes the Customer Interface Display content to maximize visibility when in a very bright environment. FIG. 31 shows a screen with a content affected by the outside bright light. The VMC detects the condition and the screen is replaced with the one in FIG. 32 which is much less washed out.

The User Interface Options Module 2 connects with the Base Board 1 and receives data to be displayed on the LCD-TFD display. The display will connect directly to the UI board. Display vendors have not standardized on a connector format; different displays will require updates to the UI board.

Vandalism is a real concern in a vending machine in all but the most secure, high visibility locations. A TFT screen must be protected behind some type of plastic lens, and the display may need to be shimmed away from the lens to allow for a little flex. The interface to a display touch screen is constructed as a layer on top of the protection lens. If vandalism occurs, the lens and touch screen will be replaced without needing to change any costly electronics. The VMC supports both capacitive and resistive screens.

Resistive touch screens provide the benefit that they are cheap and simple to implement. They also work well in all weather conditions even if a consumer is wearing gloves. It does have two distinct disadvantages. First, the consumer must make contact with the touch screen. Second, a resistive screen will reduce display brightness by 10-20%.

Capacitive screens are extremely robust. The ITO layer used for a capacitive screen only decreases brightness by 3-5% so the same screen will be sharper with a capacitive touch screen. In the context of a vending application, capacitive screens do have some significant drawbacks. First, the lens that is required to protect the display will reduce the resolution available on the capacitive screen. A second drawback is environmental performance. Capacitive screens may erroneously sense key presses when the screen gets wet during a rain event. A third characteristic we have observed is sensitivity to the clothing being worn. It is possible for gloves with certain coatings, including driving gloves and batting gloves, to disrupt the capacitive field differently than a bare finger. This results in either making an extremely sensitive screen or requiring the consumer to remove their gloves.

The backlight control circuitry is located on the User Interface Module; just as was the case with connectors, the different backlight drives will be transparent to the VMC software. Every item placed between the glass in the display and the consumer will have an impact to brightness and introduce the possibility for glare. The display lens is coated to improve direct-sunlight performance and has at least 800 nits to be legible on a bright day.

FIG. 18 item 3 is the Online connecting Module, Online Module. The Online Module connects with the VMC Base via the “Online” port 12 of FIG. 18. It has the ports for adding telemetry and cashless functionality to the vending machine. The cashless card reader interfaces, the interface buttons and the modem/antenna for connectivity to the external clearing house and internet are located on this Module. The VMC has the software application that provides cashless processing and telemetry functions. This application communicates directly with the cashless reader on the vending machine; coordinates with the GUI application to display consumer prompts; and communicates with the external servers via a network connection to process cashless media, collect audit data, etc.

FIG. 18 item 4 is the Service Module. This board is an option to provide remote location of the DEX plug, service mode button, and field service USB port. This functionally may also be present on a Machine Specific Module.

FIG. 18 item 5 is a Machine Specific Module. This module handles the entire functionality specific to the type of vending machine. Examples of the functionality here are the actual hardware and routines to vend a product; the control for the refrigeration specific to the machine; support for vending machine displays.

The modular construction of the Vending Machine Controller allows it to adapt new features to an existing or new vending machine. A vending machine like the one presented in the U.S. Pat. No. 6,427,912, which accepts credit via a credit card that is locally validated does not require connectivity to a network for validation of a credit card. The only module that will be affected will be the Online Module of FIG. 18. The Module will allow the connection of a Cashless Reader however it will not have a modem or other means for external connectivity. The cashless functions are built in the VMC and will directly perform the credit authorization.

The modem/antenna on the Online Module allows for communications with cellular networks. The Vending Machine Controller with its near-field communication (NFC) routines is capable to recognize requests for price and availability coming from a cellular network/cellular telephones via the Online Module. Following the request, the VMC will check its own vending machine available stock and price of the requested product and initiate a search in the nearby vending machines of the same network. Finally the VMC will respond to the cellular network/cellular phones with price and availability of the product in its own vending machine and the one closed by in its network.

Thus, there has been shown and described a novel system and method for making a Vending Machine Controller out of modules which system and method fulfill the various objects and advantages sought therefore. Thus it will be easier to adapt new features to an existing or new vending machine. That using temperature sensor it is advantageous for the VMC to vary the content on a LCD-TFT display, display different advertisements for different temperature ranges and or switch from fast-moving content to slower or static content as the outside temperature drops to counteract a viscosity change of the liquid crystal. Further more that using an ambient light sensor to control the LCD-TFT display to switch from high-motion, high-color media files to a design with high contrast; to control backlight brightness to provide a common display look across ambient conditions; to control the brightness of LED lighting inside the vending machine; to turn off the machine lights and/or automatically enter the storage temperature for refrigeration to conserve power. Further more that building cashless and telemetry functions directly into the VMC and having the Online Module connecting to the outside networks and internet allows the VMC to perform credit authorization at the clearing houses and Vending telemetry functions without an additional device; the VMC could directly track and manage “contests and loyalty” programs; the VMC and the touch screen allows a customer to sign into a PayPal, Google Wallet, or iTunes account to pay for a product without needing any other payment media or using the smart cellular phone. Further more the Online Module facilitates finding a product and its price in a Vending Machine or in one of the Vending Machines of a nearby network of vendors.

It will be apparent to those skilled in the art, however, that many changes, variations, modification and other uses in applications of the subject system and method are possible, and all such changes, modifications, and other uses in applications which do not depart from the spirit and scope of the invention are deemed to be covered by the invention which is limited only be the claims which follow.

1. A vending machine comprising:
a cashless payment reader for reading a customer's cashless payment device
a vending machine controller for receiving information from the cashless payment reader, calculating credit acceptance, calculating credit return, signaling product dispensing, and displaying information on a display, and further comprising a network interface controller for communicating information about the customer's cashless payment device across a network and for receiving information about whether the cashless payment device is valid for making a purchase from the vending machine;
a product dispenser for dispensing a product in response to an instruction from the vending machine controller;
a touch screen display for communicating messages from the vending machine controller to a customer and for interpreting customer contact with the display,
wherein the vending machine controller is adapted to provide a plurality of regions on the touch screen display comprising a first region providing advertising or location specific information related to products sold by the vending machine, a second region displaying the products sold by the vending machine, and a third region displaying information about an interactive promotion or rewards program related to the products sold by the vending machine;
wherein the touch screen display communicates information about a customer contacting the second region to the vending machine controller to view products available from the vending machine and to select products for vending from the vending machine;
wherein the touch screen display communicates information about a customer contacting the third region to the vending machine controller to allow a customer accomplish at least one task selected from the group consisting of: registering for a promotion or reward, participating in a promotion or reward, and selecting product from the vending machine with credit obtained from a promotion or award; and
wherein the vending machine controller is adapted to communicate with network interface to receive information and images for display within the plurality of regions;
wherein the vending machine controller is adapted to communicate with the network interface to accomplish at least one task selected from the group consisting of: registering a customer for a promotion or reward, allowing a customer to participate in a promotion or reward, and receiving credit for dispensing product within the vending machine for participation in a promotion or reward program.

2. The vending machine of claim 1 further comprising a sensor for monitoring an external environmental condition and wherein the vending machine controller is adapted to transmit the status of the environmental condition to a server via the network communication device.

3. The vending machine of claim 1 further comprising a sensor for monitoring an external environmental condition and wherein the vending machine controller is adapted to alter the information displayed on the touch screen display based upon the environmental condition.

4. The vending machine of claim 1 further comprising:
a coin acceptor for validating coins received from a customer and paying out coins to a customer as change, wherein the coin acceptor transmits information about valid coins received to the vending machine controller and receives information from the vending machine controller indicting coins to be paid as change; and
a bill acceptor for validating bills received from a customer wherein the bill acceptor transmits information about valid bills received to the vending machine controller.

5. The vending machine of claim 4 further comprising a bill dispenser for paying out bills to a customer as change; wherein the bill dispenser receives information from the vending machine controller indicting bills to be paid as change.

6. The vending machine of claim 1 wherein the cashless payment device is selected from the group consisting of: credit and debit cards incorporating a magnetic stripe, credit and debit cards incorporating contactless communication devices, credit and debit cards incorporating contact-based communication devices, and handheld, mobile electronic devices incorporating payment systems using contactless communication technology.

7. The vending machine of claim 1 further comprising a plurality of sensors for sensing a condition of the vending machine controller, each sensor being connected to the vending machine controller to indicate the sensed condition, and wherein the vending machine controller is adapted to communicate the sensed condition via the network interface controller to a server attached to the network.

8. The vending machine of claim 7 wherein the sensed condition is selected from the group consisting of: volume of product sold, amount of bills and coins contained in the vending machine, and an internal temperature of the vending machine.

9. The vending machine of claim 1 wherein the network interface controller is selected from the group consisting of: a cellular interface controller, a WiFi interface controller, a wireless interface controller, a wired interface controller, and an Ethernet interface controller.
